(19) United States
(12) Patent Application Publication
(10) Pub. No.: US 2009/0115212 A1
(43) Pub. Date: May 7, 2009

(54) Head Frame for Engaging Spreaders

(75) Inventors: Ghee Hua Ng, Singapore (SG); Zhan Min Tong, Singapore (SG); Jin Bei Tang, Singapore (SG); Robert Arthur Mills, Lancashire (GB)

Correspondence Address: Nanda P.B.A. Kumar;Reed Smith LLP, 2500 One Liberty Place, 1650 Market Street, Philadelphia, PA, 19103, US

(73) Assignee: NSL ENGINEERING PTE LTD., SINGAPORE (SG)

(21) Appl. No.: 11/883,727

(22) PCT Filed: Jan. 27, 2006
(86) PCT No.: PCT/SG06/00015

§ 371 Date: Jun. 4, 2008

(30) Foreign Application Priority Data
Feb. 2, 2005 (SG) 200500670-5

(51) Int. Cl. B66C 1/66

(52) U.S. Cl. 294/81.2; 294/81.61; 294/81.3

(57) ABSTRACT

A hoist frame (150) for engaging a pair of spreaders in an expanded position and a single spreader in a retracted position comprising, a first and second head frame (65a, b), each for engaging a lifting device; a rigid first frame (160a) fixed to the first head frame and a rigid second frame (160b) fixed to the second head frame; a plurality of assemblies (155a,b) pivotably mounted to each fixed frame so as to be intermediate the head frames, wherein, each assembly comprises an upper horizontal member (175), a first inclined outer member (165) pivotally mounted to the first fixed frame and pivotally mounted to a first end of the upper horizontal member, a second inclined outer member (185) pivotally mounted to the second fixed frame and pivotally mounted to a second end of the upper horizontal member, a first inclined inner member (170a) pivotally mounted to the first fixed frame and pivotally mounted to a mid-point of the upper horizontal member so as to be parallel to the first outer inclined member in a first position of the hoist frame and a second inclined inner member (180) pivotally mounted to the second fixed frame and pivotally mounted to a mid-point of the upper horizontal member so as to be parallel to the second outer inclined member in a first position of the hoist frame, such that the first members and the first fixed frame define a first parallelogram (217), and the second member and the second fixed frame define a second parallelogram (216).

### FIELD OF INVENTION

The invention relates to the movement of freight devices, for instance, a container. Specifically the invention relates to the apparatus used for the movement of said freight devices and in particular, the apparatus and method of engaging a freight device and manipulating said freight device in order to facilitate its movement. Whilst the use of the present invention is not restricted to any particular type of freight device, it will be convenient to describe its applicability to containers as these represent the most common form of freight device.

### BACKGROUND

In order to increase the flow of freight through, for instance, a port, systems have been developed whereby multiple freight devices such as containers may be engaged by hoisting systems simultaneously. Theoretically, these systems increase the flow of freight by a factor of two. However, these theoretical increases in freight flow depend upon the containers being of identical size, shape and location, when, in fact, such a variation can occur often enough to disrupt and reduce this theoretical efficiency. A variation in any of these factors can slow the flow of freight because of increased complexity in engaging the containers, a slower rate of transport because of the difficult terrain or even abandoning a double engagement because of, for instance a sizeable differential in weight and/or height

It follows therefore that the promise of the multiple container lifting apparatus that have been developed is rarely met because of the non-homogeneity of the loading conditions and of the containers themselves.

### SUMMARY OF INVENTION

It is therefore an object of the present invention to more effectively accommodate variations in loading conditions and so be more universally applicable to different situations.

Therefore in a first aspect, the invention provides a hoist frame for engaging a pair of spreaders in an expanded position and a single spreader in a retracted position comprising, a first and second head frame, each for engaging a lifting device; a rigid first frame fixed to the first head frame and a rigid second frame fixed to the second head frame; a plurality of assemblies pivotably mounted to each fixed frame so as to be intermediate the head frames, wherein, each assembly comprises an upper horizontal member, a first inclined outer member pivotally mounted to the first fixed frame and pivotally mounted to a first end of the upper horizontal member, a second inclined outer member pivotally mounted to the second fixed frame and pivotally mounted to a second end of the upper horizontal member, a first inclined inner member pivotally mounted to the first fixed frame and pivotally mounted to a mid-point of the upper horizontal member so as to be parallel to the first outer inclined member in a first position of the hoist frame and a second inclined inner member pivotally mounted to the second fixed frame and pivotally mounted to a mid-point of the upper horizontal member so as to be parallel to the second outer inclined member in a first position of the hoist frame, such that the first members and the first fixed frame define a first parallelogram, and the second members and the second fixed frame define a second parallelogram.

In a second aspect, the invention provides a hoist frame for engaging a pair of spreaders in an expanded position and a single spreader in a retracted position comprising, a first and second head frame, each for engaging a lifting device

A rigid first frame fixed to the first head frame and a rigid second frame fixed to the second head frame; a plurality of assemblies pivotably mounted to each fixed frame so as to be intermediate the head frames, wherein, the assemblies comprise first and second inclined members respectively mounted to the fixed frames, and connected through an apex connection.

In a third aspect, the invention provides a hoist frame for engaging a pair of spreaders in an expanded position and a single spreader in a retracted position comprising, a first and second head frame, each for engaging a lifting device; a rigid first frame fixed to the first head frame and a rigid second frame fixed to the second head frame; a plurality of nestable driven assemblies pivotably mounted to each fixed frame so as to be intermediate the head frames, wherein the nestable driven assemblies cause selective relative movement of the head frames and retract to nest so as to permit contact between the head frames through interleaving of the fixed frames.

It will be clear to the skilled addressee that lifting device encompasses known variations in this field, including a spreader or an intermediate device such as an adapter frame.

The invention accommodates a plurality of assemblies to manipulate the head frames in a relative fashion. It further provides for a retracted position that decreases the space required by the hoist frame, leading to less weight, and less manufacturing cost. Thus, in a preferred embodiment, the hoist frame may operate at a fully extended width of 6 metres, but be able to retract to a width of 1 metre.

In a preferred embodiment, the assemblies may be biased by a plurality of integrally mounted actuators. In a more preferred embodiment, said actuators may be electrically hydraulically or pneumatically driven.

In a preferred embodiment, relative longitudinal movement may be effected by at least a pair of orthogonal actuators are mounted generally in a direction orthogonal to longitudinal axes of the head frames. In a further preferred embodiment, activation of one of said actuators, may cause the head frames to be rotated relative to each other within a plane defined by the head frames.

In a preferred embodiment, the driven assemblies may comprise first and second inclined members respectively mounted to the fixed frames, and connected through an apex connection, said orthogonal actuators mounted from the first fixed frame to the second inclined members. In this embodiment, the assemblies may resemble A-frames directed upwards. Alternatively, the members may be located in a plane parallel to that defined by the head frames, so long as the arrangement meets the essential criteria of being nestable.

In a preferred embodiment, the apex connection may include an intermediate portion pivotally connected to the first inclined member and pivotally connected to the second inclined member, the longitudinal actuator mounted between the intermediate portion an end of the first inclined member, such that on activation of the longitudinal actuator, the distance from the end of the first inclined member to the pivotal connection with the intermediate portion acts as a lever arm to achieve the longitudinal relative movement of the head frames. In this way, rather than the actuator bearing directly on the head frame for longitudinal movement, the head frames may be levered in this direction, with the assemblies ensuring the motion is purely longitudinal without a transverse component.

In a more preferred embodiment each nestable assembly may include an upper horizontal member, a first inclined outer member pivotally mounted to the first fixed frame and pivotally mounted to a first end of the upper horizontal member, a second inclined outer member pivotally mounted to the second fixed frame and pivotally mounted to a second end of the upper horizontal member, a first inclined inner member pivotally mounted to the first fixed frame and pivotally mounted to a mid-point of the upper horizontal member so as to be parallel to the first outer inclined member in a first position of the hoist frame and a second inclined inner member pivotally mounted to the second fixed frame and pivotally mounted to a mid-point of the upper horizontal member so as to be parallel to the second outer inclined member in a first position of the hoist frame, such that the first members and the first fixed frame define a first parallelogram, and the second members and the second fixed frame define a second parallelogram. The parallelogram provides the advantage of pivotal movement whilst maintaining the parallel relationship of the members. Further, by adding preferable locking components, the parallelogram orientation is particularly rigid, adding strength to the hoist frame.

### BRIEF DESCRIPTION OF DRAWINGS

FIG. 1A is a an isometric schematic view of the axes used to define the orientation of the hoist frame;

FIGS. 1B to 1G are schematic views of the relative degrees of freedom that are possible for two head frames;

FIG. 2 is an isometric view of an adapter frame and a spreader for use with the present invention;

FIG. 3 is an isometric view of a hoist frame according to one aspect of the present invention;

FIG. 4 is an isometric view of a hoist frame according to another aspect of the present invention;

FIG. 5 is an isometric view of the hoist frame of FIG. 4 following transverse translation of the head frames;

FIG. 6 is an isometric view of the hoist frame of FIG. 4 in the fully retracted position;

FIG. 7 is a plan view of the hoist frame of FIG. 4;

FIG. 8 is an isometric view of the hoist frame of FIG. 4 following longitudinal translation of the head frames;

FIG. 9 is an end elevation view of the hoist frame of FIG. 4 following relative rotation of the head frames about the longitudinal axis;

FIG. 10 is an end elevation view of the hoist frame of FIG. 4 following relative lifting of the head frames;

FIGS. 11A to 11C show the process lowering two dissimilar sized containers according to one embodiment of the present invention;

FIGS. 12A to 12C and 13 show an alternative process of lowering dissimilar sized containers according to another embodiment of the present invention.

### DESCRIPTION OF PREFERRED EMBODIMENT

It will be convenient to further describe the present invention with respect to the accompanying drawings, which illustrate possible arrangements of the invention. Other arrangements of the invention are possible and consequently, the particularity of the accompanying drawings is not to be understood as superceding the generality of the proceeding description of the invention.

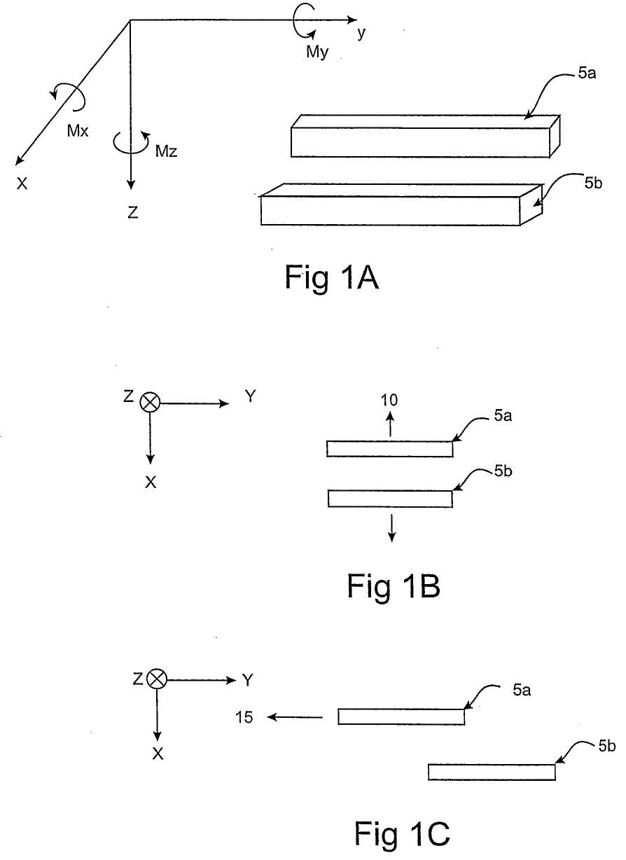

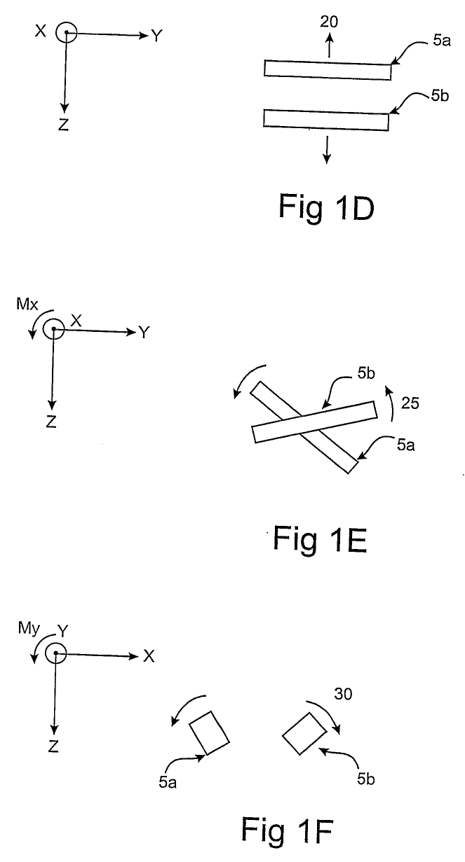

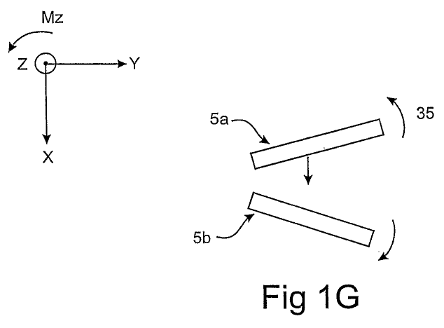

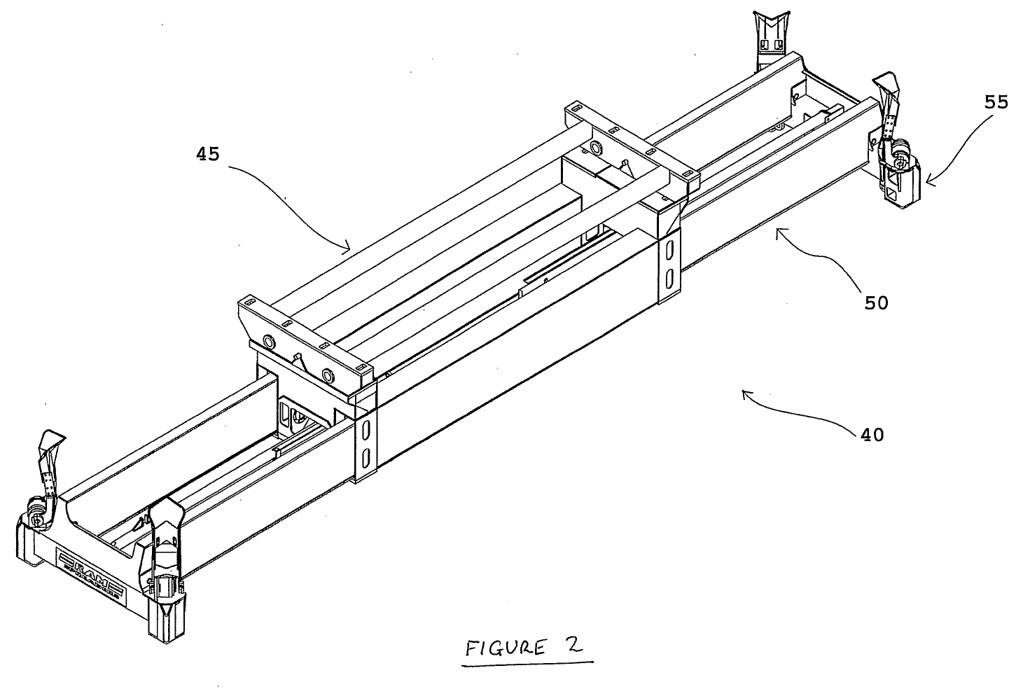

In describing the applicability of the invention, it is important to recognize the variations in position that must be accommodated by the apparatus of the present invention. To this end, FIG. 1a shows an axis system defining X, Y and Z axes and rotation about each axis defined as Mx, My and Mz. Each of these designations define a degree of freedom which the apparatus may preferably accommodate in order to be applicable to a variety of situations. A schematic view of two containers 5a,b are aligned parallel to each other with their longitudinal axis parallel to the Y axis. Thus, the containers are placed in spatial relation to each other along the X axis with the Z axis directed downward. By defining relative positions of the two containers, and equating these with each degree of freedom, the various embodiments of the present invention may be compared so as to determine which relative positions may be accommodated by the various embodiments of the present invention.

FIG. 1b indicates a relative change in position moving the containers relative to each other along the X axis. This will be defined for clarity as “separation”.

FIG. 1c shows a relative change in position of the containers along a longitudinal path and so a relative movement parallel to the Y axis. This will be defined as an “off-set”.

FIG. 1d shows a relative change of position parallel to the Z axis, which equates to a height differential between the containers.

FIG. 1e shows a relative rotation about the X axis equating to one end of one container rising relative to other container, which will be defined as “trim”.

FIG. 1f shows a rolling of one container relative to the other about the Y axis.

FIG. 1g shows a relative rotation of the containers about the Z axis, which will be defined as “skew”.

These degrees of freedom are based on relative movement of the containers. The containers acting as a single unit are also capable of six degrees of freedom being both translation and rotation. These are normally accommodated by the crane and therefore are not subject to control by the head frame per se. Therefore an assessment of the various embodiments of the present invention will be confined to those degrees of freedom based upon relative movement.

FIG. 2 shows an intermediate frame 40 to which any one of the head frames according to the present invention may attach. In particular, the intermediate frame 40 comprises an adapter frame 45 and a spreader 50 adapted to engage a container through twist lock engagements devices 55.

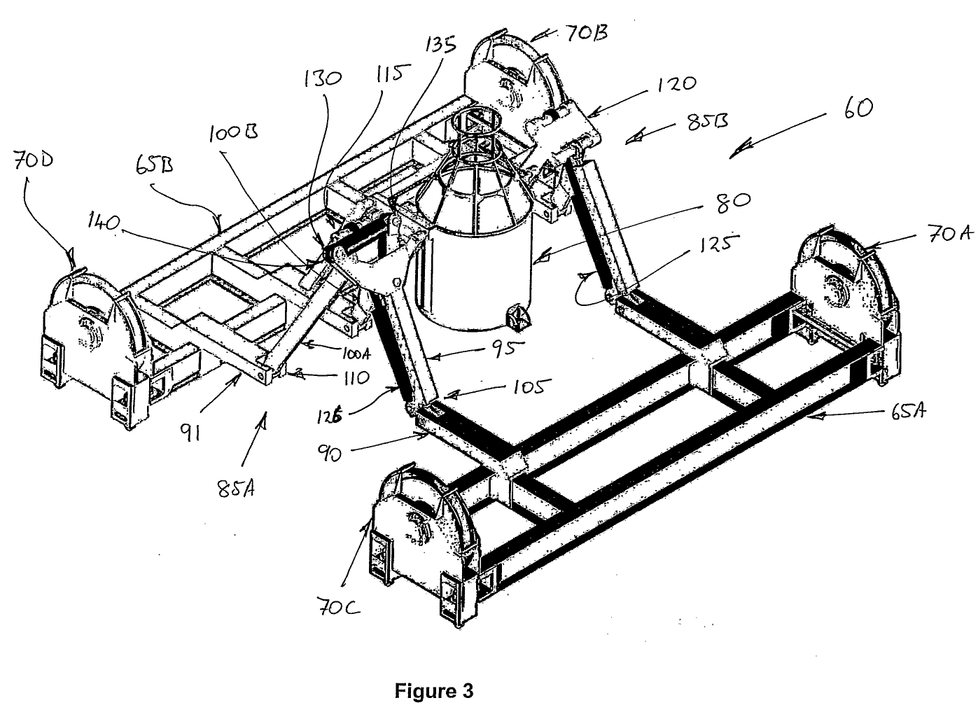

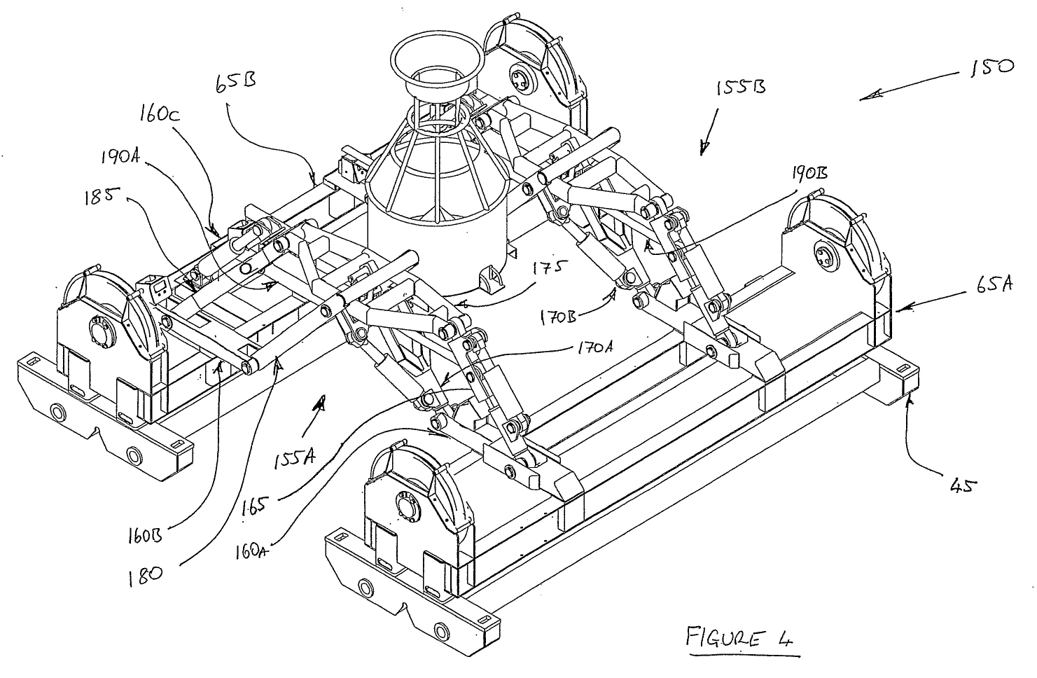

FIG. 3 shows one aspect according to the present invention, comprising a hoist frame 60. The hoist frame 60 includes two head frames 65a,b, which may engage the intermediate frame 40. The head frames 65a,b are connected through assemblies 85a,b located at opposed ends of the head frames. It is these assemblies 85a,b that facilitate the relative movement of the head frames 65a,b. The hoisting frame 60 is connected to the crane or trolley controlling the movement of the hoisting frame 60 through sheaves 70a,b,c and d by cables connecting these portions. Further, the hoisting frame 60 may contain a cable basket 80.

Referring now to the assemblies 85a,b said frames are similar in appearance comprising members 90, 91 integrally fixed to each of the head frames 65a,b. Attached to these fixed members 90, 91 are inclined members 95, 100 which are pivotally connected to the fixed members 90, 91 and also pivotally connected to each other to form a vertically extending A-frame. The pivotal joints 105,110 vary from the inclined members 95, 100 in that on the first head frame 65a, the inclined members 95 are connected to the fixed frame 90 through universal joints 105 permitting rotation in at least two orthogonal directions. Conversely the second head frame 65b has at least two inclined members, 100a,b, which are both connected to the fixed frame 91 through a pin-joint 110 permitting a rotation about the Y axis as discussed in FIG. 1a, but preventing rotation in any other direction.

The apex connection 115 connecting inclined members 100a,b & 95 also involve a universal joint. Given the universal connection 105, this permits the inclined member 95 to rotate in any direction and consequently the first head frame 65a, subject to the inclusion of other elements, is permitted to move a relative to the second head frame 65b in several directions.

The assemblies 85a,b further include actuators 125, 126 having a reaction bearing from the first fixed frame 90 and a second reaction point bearing on second inclined members 100a,b. The actuators are inclined upwards, but at a flatter angle to first inclined members 95. On simultaneous actuation, actuators 125, 126 will move the second frame 65b parallel to the X axis and thus affect a translation along the X axis of the frames 65a,b. However, if one actuator 126 is activated, and the second actuator 125 held at a fixed length, then the head frames 65a,b will tend to rotate in a skew fashion as shown in FIG. 1g, being a relative rotation Mz about the Z axis.

Thus, the selective actuation of the actuators 125, 126 achieve two degrees of freedom or relative movement of the head frames 65a,b.

The apex connection 115 further includes a sub-assembly whereby the inclined member 95 includes an extension 135, having a free end. Further a pivotal portion 140 permitting limited rotation is attached at one end, a further actuator 130 bearing between the pivotal portion 140 and the free end 135 of the inclined member 95. The actuator is generally directed parallel to the Y axis and the rotational portion 140 is connected to the apex connection 115. On actuation of the actuator 130, the rotational portion connected to the apex connection 115 will stay fixed causing the free end 135 to move relative to the apex connection and consequently, given the universal connections of the inclined member 95, cause a relative movement of the head frame 65a,b parallel to the Y axis corresponding to the off-set shown in FIG. 1c. Consequently, the inclusion of this actuator 130 within the apex connection 115 leads to a further degree of freedom of relative movement.

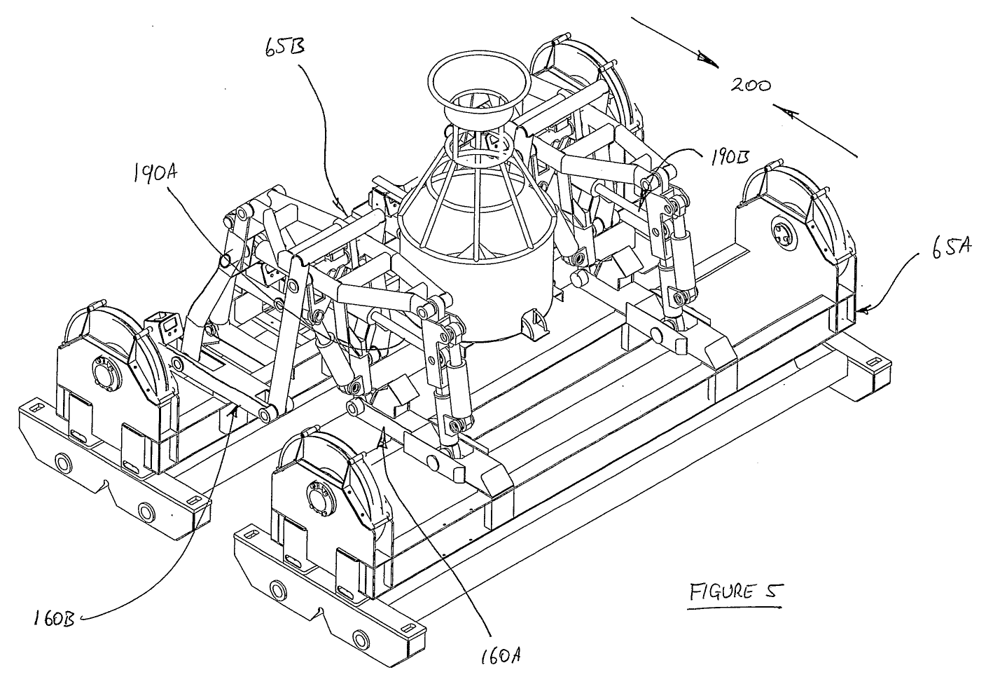

The FIG. 4 shows a second aspect of the hoist frame 150. As with the previous aspect shown in FIG. 3, the hoist frame 150 includes two head frames 65a,b which are attachable to adapter frame 45. Further the head frame 65a,b are connected through two assemblies 155a,b and it is through these assemblies 155a,b that this embodiment differs from that shown in FIG. 3.

The intent of this aspect is to create assemblies 155a,b having a frame work of members forming parallelograms and so introduce a marked increase in strength and rigidity. Again the assemblies 155a,b are similar in the construction. Taking the first assembly 155a, the framework of members comprises an upper horizontal member 175 which is connected to the first head frame 65a through two inclined parallel members 165 and 170, both which are pivotally connected to a fixed frame 160a and pivotally connected to the horizontal member 175. The second head frame 65b includes pairs of inclined members 180 and 185 again pivotally connecting the horizontal member 175 to the fixed frame 160b. Thus, the first parallelogram is formed by first inclined members 165 and 170, the fixed frame 160a and a portion of the upper horizontal member 175. The second parallelogram is formed by pairs of inclined members 180 and 185 with second fixed frame 160b and the remaining portion of the upper horizontal member 175.

A further variation of this aspect is the placement of the actuator 190. In this aspect, the actuator is positioned parallel to and beneath the upper horizontal member 175, finding reaction with the outer inclined members 165 and 185. With the similar assemblies 155a,b having similar actuators, the separation mode shown in FIG. 1b is achieved through a simultaneous actuation of the actuators 190a,b.

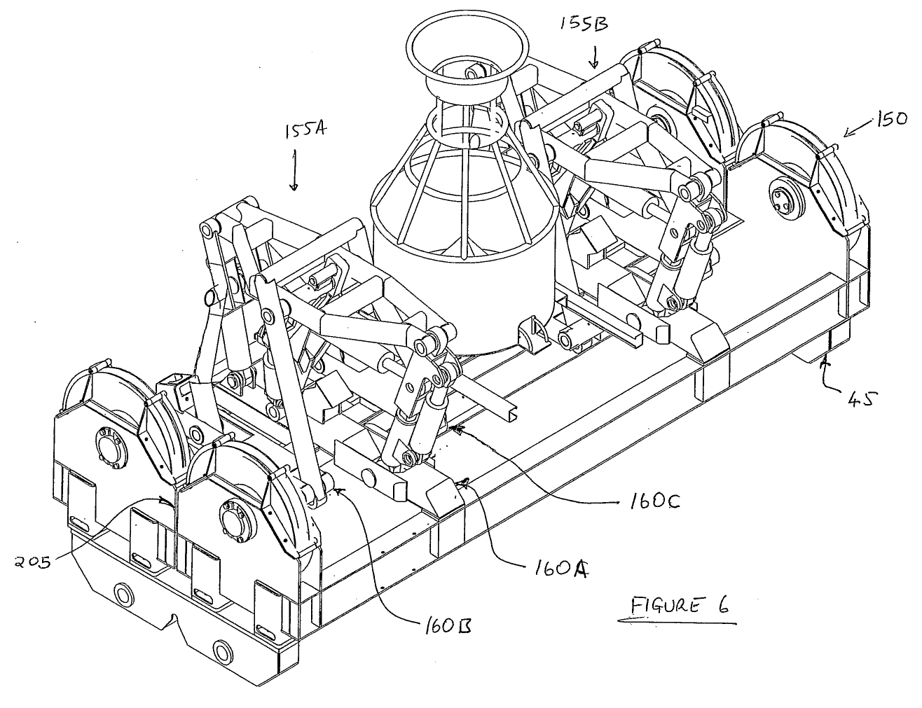

FIG. 5 shows the result of simultaneous retraction of the actuators 190a,b. In this orientation, the relative movement 200 draws the head frames 65a,b towards each other until the fixed frames 160a,b are adjacent. FIG. 6 shows the result of further retraction of the actuators 190a,b and demonstrate the “nestability” of the invention that is inherent with both the embodiments shown in FIGS. 3 and 4. In the fully retracted position, the fixed frames 160a,b have interleaved following the assemblies 155a,b folding within themselves into a more compact arrangement. The result is the head frames 65a,b coming into imminent or actual contact 205 for attachment to a single adapter frame 45 such that the hoist frame 150 is adapted for use for attachment to a single container.

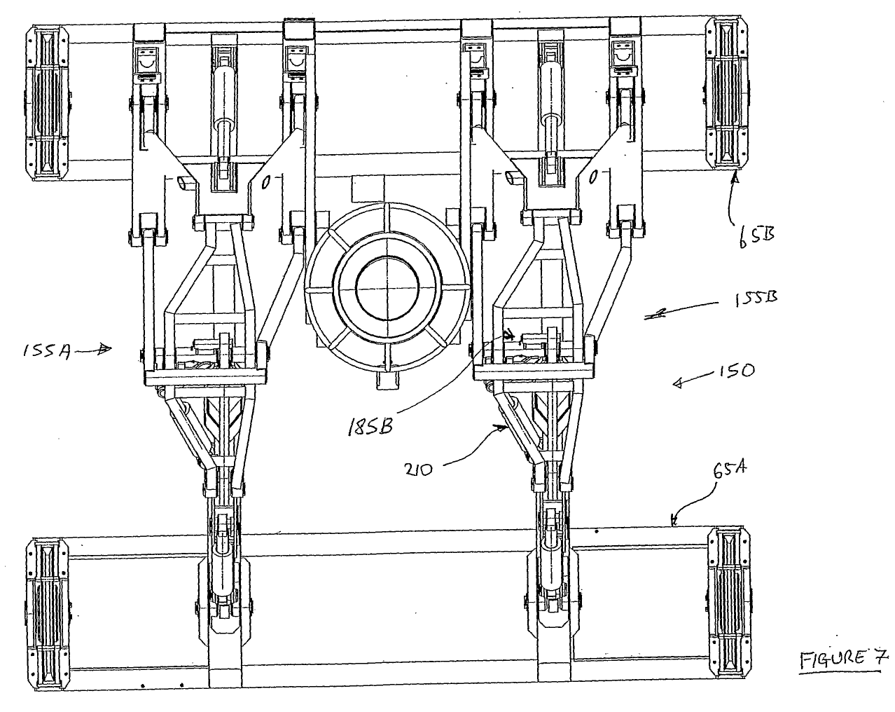

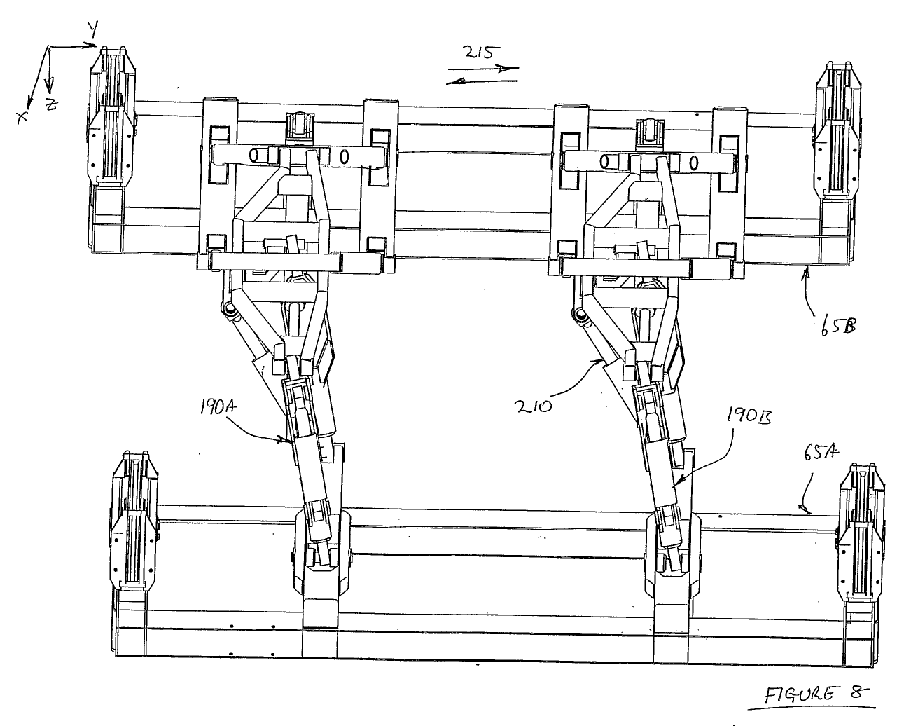

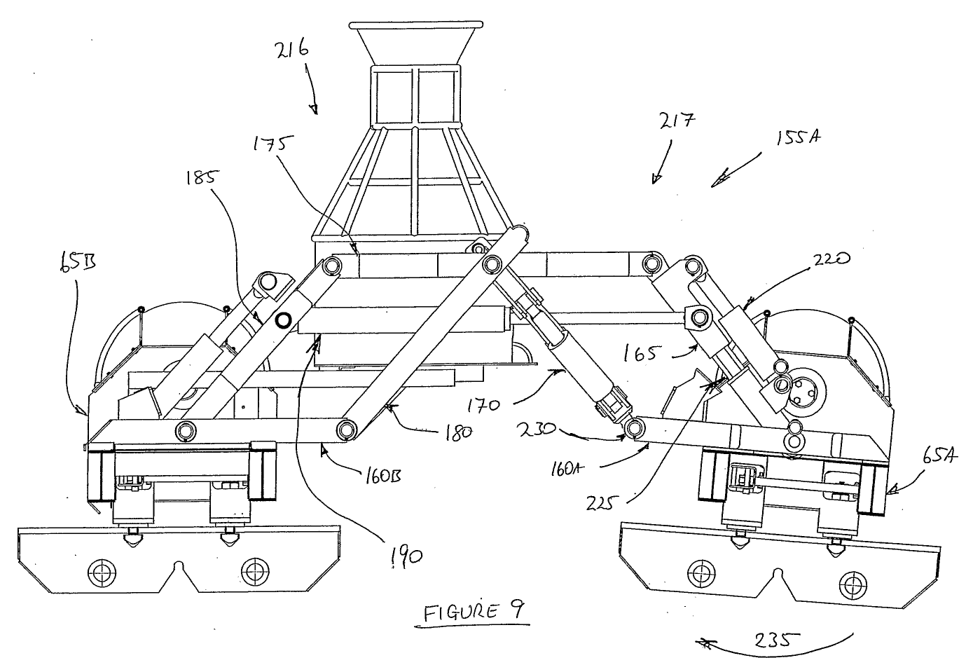

FIG. 7 shows a plan view of the hoist frame 150 as shown in the fully extended arrangement according to FIG. 4. This view provides a more clear view of the third actuator 210, which is oriented at an angle to the Y axis on the second assembly 155b. The actuator is mounted between the peripheral member 185b and the inner inclined member 170b mounted on the first head frame 65a of the second assembly 155b. As shown in FIG. 7, actuation of this inclined actuator 210 leads to a relative motion of the head frames 65a,b parallel to the Y axis corresponding to the off-set shown by the motion of FIG. 1c.

FIG. 9 shows an elevation view of the first assembly 155a showing the framework of members forming the parallelograms. In particular the parallelogram 216 associated with the second head frame 65b, comprises inclined members 180, 185 and horizontal members 160b and a portion of the upper horizontal member 175. The first parallelogram 217 associated with the first head frame 65a comprises horizontal members 160a and the remaining portion of the upper horizontal member 175 and inclined members 165 and 170. A feature of inclined member 165, however, is its connection to an actuator 220, which lies parallel to the inclined member 165. Further, the inclined member 165 differs from the corresponding inclined member 185 on the second parallelogram 216 in that it can lengthen 225 according to the extension or retraction of the parallel actuator 220. To achieve a relative rotation 235 about the Y axis, the actuator 220 is extended so as to extend the length 225 of the inclined member 165. This causes rotation at the vertices of the first parallelogram 217 deforming the parallelogram shape to form a quadrilateral. Consequently, member 160a rotates about vertex 230 and so is no longer parallel to upper horizontal member 175, which remains fixed in position and length, and the first head frame 65a rotates according to the distortion in shape of the first parallelogram (now quadrilateral) 217. Consequently, the relative rotation 235 about the Y axis, as shown in the motion of FIG. 1f is achieved. It will be noted also that, in the situation where the head frame 65a is lowered such that the attached container contacts an inclined surface, on release of the actuator 220, the frame will self adjust through the application of force applied by contact with the ground as the container is lowered.

A further example of the self adjustment of the invention is shown in FIG. 10. On application of an upward load 240, such as the situation when the container engaged with head frame 65b contacts the ground before the container engaged with the other head frame 65a, the frame will adjust in shape, maintaining the upper horizontal member 175 horizontal, permitting a relative shift upwards of the second head frame 65b. This relative shift 240 may also be effected by the trolley, whereby the second head frame 65b is lifted by cables relative to the first head frame 65a.

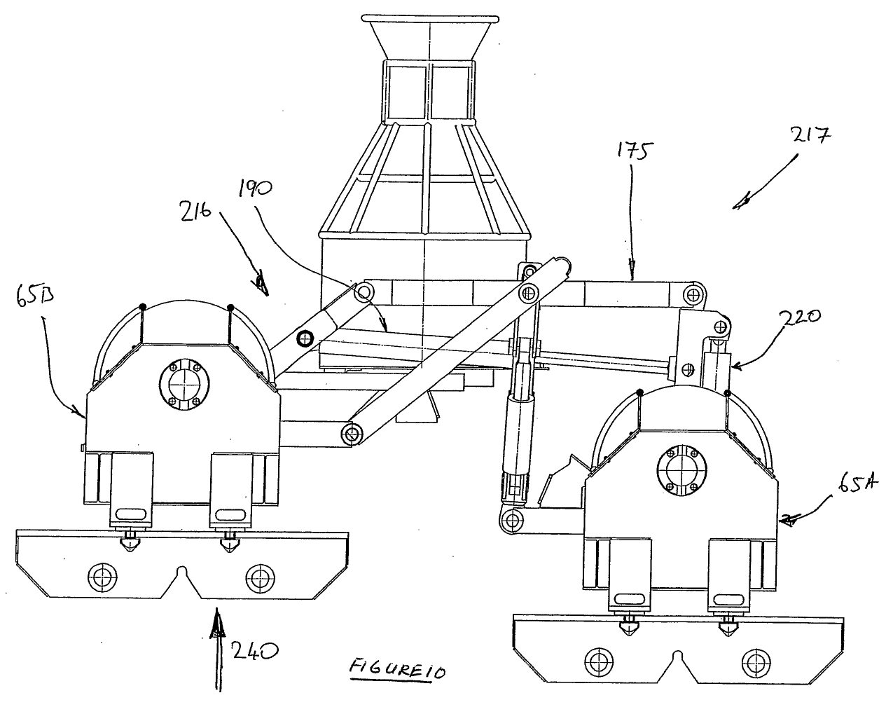

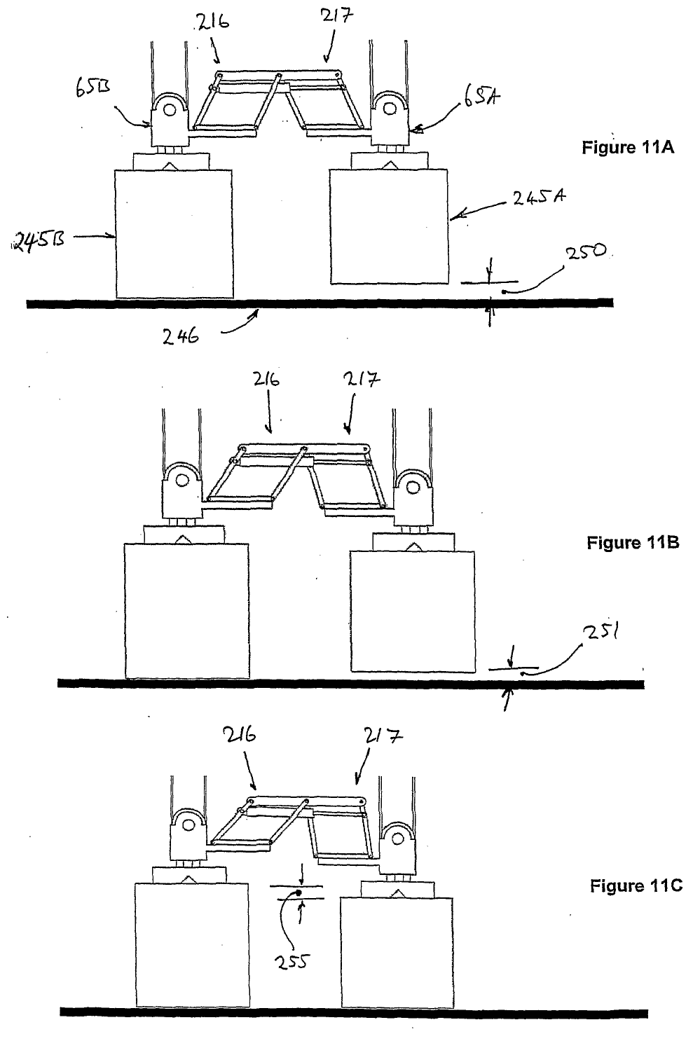

FIGS. 11a, 11b and 11c show a particular application of the movement shown in FIG. 10. FIG. 11 shows the first and second head frames 65a,b at the same height with the first head frame 65a engaged with a container 245a, which is smaller than the container 245b engaged by the second head frame 65b. In this example, it is desired to place both containers 245a,b on the flat surface 246. On contact with the ground, the second container 245b deforms the parallelogram of the second head frame 65b, as the assembly self-adjusts its shape to accommodate the differential in height between the containers 245a,b. The effect is to change the relative height of the head frames 65a,b and reducing the gap 251 between the bottom of the container 245a and the ground 246, until both containers contact the ground as shown in FIG. 11C.

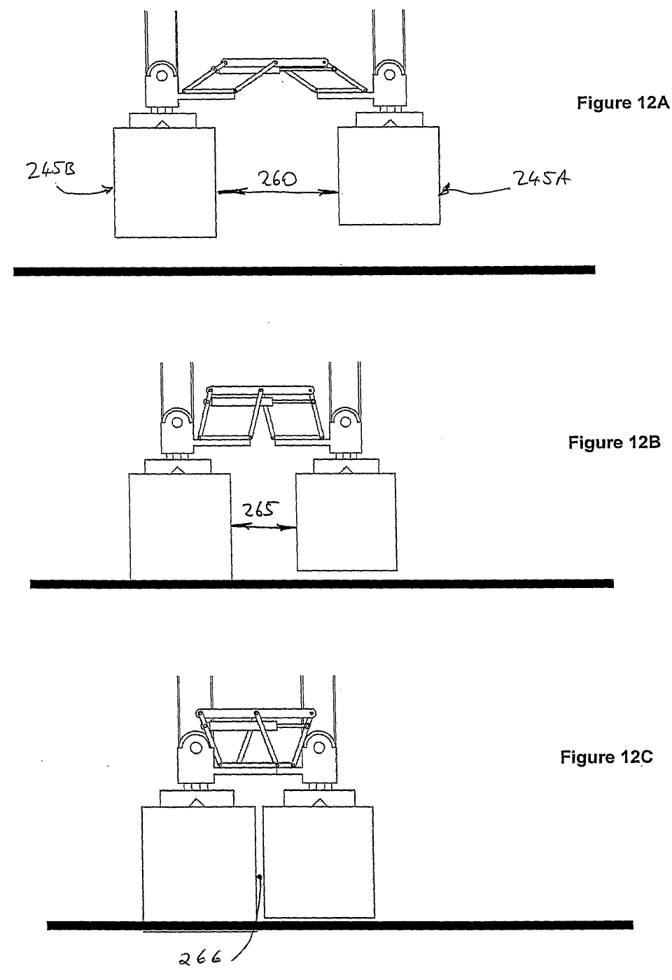

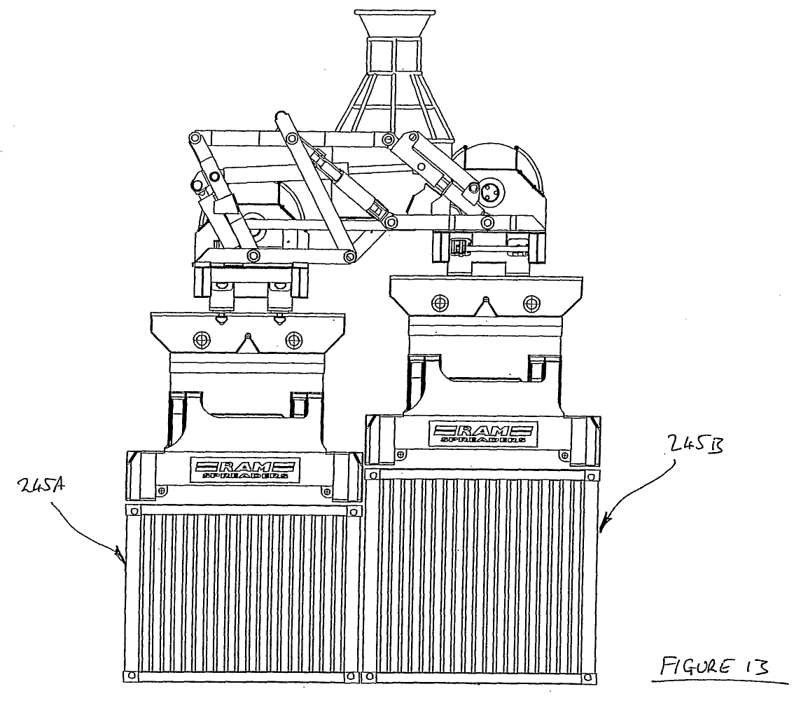

An alternative example is shown in FIGS. 12a, 12b, 12c and 13. Whereas the examples shown in FIGS. 11a to 11c did not require the containers 245a to 245b to be in close proximity. The examples shown in FIGS. 12a to 12c and 13 require the containers to be placed in close proximity. Thus as shown in FIG. 12a, the containers are held at a full separation 260 and the containers are then lowered to the ground as shown in FIG. 12b. As the second container 245b is larger, it will contact the ground first. Further retraction of the horizontal actuators 190 whilst permitting free movement of actuator 220, drawing the first container 245a into close proximity with the second container 245b whilst the first container 245a is still above the ground. The first container 245a is then lowered to the ground, adjusting the assembly until the desired position is achieved, as shown in FIG. 13.

The self adjustment feature of this aspect of the invention is also possible to achieve the movement as shown in FIG. 1E. By lowering the containers 5a,b onto surfaces having differential slope, has the same effect as with the height adjustment shown in FIG. 10. Thus, without the need for complex control systems to manipulate the containers, the assembly is capable of self-adjustment to automatically achieve the desired arrangement.

A further example of the benefit of the self adjustment is the application of wind loads or eccentric loadings of the containers. The containers present a significant surface area, resulting in a considerable force applied to the head frame, as does the potential for shifted or poorly packed containers, creating an eccentric load. Prior art systems accommodate unbalanced loads through rotation/swing about the head frame, and consequently, an undesirable arrangement of the containers. However, the head frames of the present invention are constrained by the rigid structure of the assemblies, and so prevented from moving. Because of the upper horizontal member 175 maintaining horizontal position, the containers remain square to the ground, until a further force causes the arrangement to self-adjust to a new desired orientation.

The claims defining the invention are as follows:

1. A hoist frame for engaging a pair of spreaders in an expanded position and a single spreader in a retracted position comprising,
A first and second head frame, each for engaging a lifting device;
A rigid first frame fixed to the first head frame and a rigid second frame fixed to the second head frame;
A plurality of assemblies pivotably mounted to each fixed frame so as to be intermediate the head frames, wherein,
each assembly comprises an upper horizontal member, a first inclined outer member pivotally mounted to the first fixed frame and pivotally mounted to a first end of the upper horizontal member, a second inclined outer member pivotally mounted to the second fixed frame and pivotally mounted to a second end of the upper horizontal member, a first inclined inner member pivotally mounted to the first fixed frame and pivotally mounted to a mid-point of the upper horizontal member so as to be parallel to the first outer inclined member in a first position of the hoist frame and a second inclined inner member pivotally mounted to the second fixed frame and pivotally mounted to a mid-point of the upper horizontal member so as to be parallel to the second outer inclined member in a first position of the hoist frame, such that the first members and the first fixed frame define a first parallelogram, and the second members and the second fixed frame define a second parallelogram.

2. The hoist frame according to claim 1 wherein the assemblies are driven by a plurality of integrally mounted actuators.

3. The hoist frame according to claim 2 wherein at least a pair of orthogonal actuators are mounted generally in a direction orthogonal to longitudinal axes of the head frames, such that on simultaneous activation, the orthogonal actuators cause relative movement of the head frames in the orthogonal direction.

4. The hoist frame according to claim 3 wherein the head frames are rotated relative to each other within a plane defined by the head frames through differential activation of the orthogonal actuators

5. The hoist frame according to any one of claims 2 to 4 further including at least one longitudinal actuator mounted within the plane defined by the head frames, so as to impart a longitudinally directed force component, said assemblies arranged to permit relative movement of the head frames within the longitudinal direction on activation of the longitudinal actuator.

6. The hoist frame according to any one of the preceding claims wherein at least one of the assemblies is located adjacent each end of the head frames.

7. The hoist frame according to any one of claims 3 to 6 wherein the orthogonal actuators are located parallel to the upper horizontal member, and pivotally mounted between an intermediate point of the first outer inclined member and the second outer inclined member.

8. The hoist frame according to any one of the preceding claims wherein the second inclined members include parallel pairs of members.

9. The hoist frame according to any one of claims 5 to 8 wherein the longitudinal actuator is pivotally mounted between the second outer inclined member and the first inner inclined member so as to impart at least a component of a longitudinal force.

10. The hoist frame according to any one of the preceding claims wherein a deforming actuator is mounted parallel to the first outer inclined member, said member extendable by the force applied by the deforming actuator.

11. The hoist frame according to claim 10 wherein the deforming actuator is arranged such that on activation the shape of the first parallelogram is deformed to a quadrilateral shape having no parallel sides, causing rotation of the first head frame about the longitudinal axis.

12. The hoist frame according to any one of the preceding claims, wherein on release of the deforming actuator, the assembly is self adjustable based on the application of an external force.

13. A hoist frame for engaging a pair of spreaders in an expanded position and a single spreader in a retracted position comprising,
A first and second head frame, each for engaging a lifting device
A rigid first frame fixed to the first head frame and a rigid second frame fixed to the second head frame;
A plurality of assemblies pivotably mounted to each fixed frame so as to be intermediate the head frames, wherein,
the assemblies comprise first and second inclined members respectively mounted to the fixed frames, and connected through an apex connection.

14. The hoist frame according to claim 13 wherein the assemblies are driven by a plurality of integrally mounted actuators.

15. The hoist frame according to claim 14 wherein at least a pair of orthogonal actuators are mounted generally in a direction orthogonal to longitudinal axes of the head frames, such that on simultaneous activation, the orthogonal actuators cause relative movement of the head frames in the orthogonal direction, said orthogonal actuators mounted from the first fixed frame to the second inclined members.

16. The hoist frame according to claim 15 wherein the head frames are rotated relative to each other within a plane defined by the head frames, through differential activation of the orthogonal actuators.

17. The hoist frame according to any one of claims 14 to 16 further including at least one longitudinal actuator mounted within the plane defined by the head frames, and so as to impart a longitudinally directed force component, said assemblies arranged to permit relative movement of the head frames within the longitudinal direction on activation of the longitudinal actuator.

18. The hoist frame according to any one of claims 13 to 17 wherein at least one of the assemblies is located adjacent each end of the head frames.

19. The hoist frame according to any one of claims 13 to 18 wherein the apex connection comprises an intermediate portion pivotally connected to the first inclined member and pivotally connected to the second inclined member, the longitudinal actuator mounted between the intermediate portion an end of the first inclined member, such that on activation of the longitudinal actuator, the distance from the end of the first inclined member to the pivotal connection with the intermediate portion acts as a lever arm to achieve the longitudinal relative movement of the head frames.

20. The hoist frame according to claim 18 or 19 wherein the second inclined member comprises a pair of inclined members each mounted to the second fixed frame, such that interleaving of the fixed frames includes the first inclined member moving in the interstitial space between the two second inclined members.

21. A hoist frame for engaging a pair of spreaders in an expanded position and a single spreader in a retracted position comprising,
A first and second head frame, each for engaging a lifting device;
A rigid first frame fixed to the first head frame and a rigid second frame fixed to the second head frame;
A plurality of nestable driven assemblies pivotably mounted to each fixed frame so as to be intermediate the head frames, wherein,
The nestable driven assemblies cause selective relative movement of the head frames and retract to nest so as to permit contact between the head frames through interleaving of the fixed frames.

22. The hoist frame according to claim 21 wherein the driven assemblies are driven by a plurality of integrally mounted actuators.

23. The hoist frame according to claim 22 wherein at least a pair of orthogonal actuators are mounted generally in a direction orthogonal to longitudinal axes of the head frames, such that on simultaneous activation, the orthogonal actuators cause relative movement of the head frames in the orthogonal direction.

24. The hoist frame according to claim 23 wherein the head frames are rotated relative to each other within a plane defined by the head frames, through differential activation of the orthogonal actuators.

25. The hoist frame according to any one of claims 22 to 24 further including at least one longitudinal actuator mounted within the plane defined by the head frames, and so as to impart a longitudinally directed force component, said assemblies arranged to permit relative movement of the head frames within the longitudinal direction on activation of the longitudinal actuator.

26. The hoist frame according to any one of claims 21 to 25 wherein at least one of the nestable driven assemblies is located adjacent each end of the head frames.

27. The hoist frame according to any one of claims 21 to 26 wherein the driven assemblies comprise first and second inclined members respectively mounted to the fixed frames, and connected through an apex connection, said orthogonal actuators mounted from the first fixed frame to the second inclined members.

28. The hoist frame according to claim 27 wherein the apex connection comprises an intermediate portion pivotally connected to the first inclined member and pivotally connected to the second inclined member, the longitudinal actuator mounted between the intermediate portion an end of the first inclined member, such that on activation of the longitudinal actuator, the distance from the end of the first inclined member to the pivotal connection with the intermediate portion acts as a lever arm to achieve the longitudinal relative movement of the head frames.

29. The hoist frame according to claim 27 or 28 wherein the second inclined member comprises a pair of inclined members each mounted to the second fixed frame, such that interleaving of the fixed frames includes the first inclined member moving in the interstitial space between the two second inclined members.

30. The hoist frame according to any one of claims 21 to 26 wherein each nestable assembly comprises an upper horizontal member, a first inclined outer member pivotally mounted to the first fixed frame and pivotally mounted to a first end of the upper horizontal member, a second inclined outer member pivotally mounted to the second fixed frame and pivotally mounted to a second end of the upper horizontal member, a first inclined inner member pivotally mounted to the first fixed frame and pivotally mounted to a mid-point of the upper horizontal member so as to be parallel to the first outer inclined member in a first position of the hoist frame and a second inclined inner member pivotally mounted to the second fixed frame and pivotally mounted to a mid-point of the upper horizontal member so as to be parallel to the second outer inclined member in a first position of the hoist frame, such that the first members and the first fixed frame define a first parallelogram, and the second members and the second fixed frame define a second parallelogram.

31. The hoist frame according to claim 10 wherein the orthogonal actuators are located parallel to the upper horizontal member, and pivotally mounted between an intermediate point of the first outer inclined member and the second outer inclined member.

32. The hoist frame according to claim 30 or 31 wherein the second inclined members include parallel pairs of members.

33. The hoist frame according to any one of claims 30 to 32 wherein the longitudinal actuator is pivotally mounted between the second outer inclined member and the first inner inclined member so as to impart at least a component of a longitudinal force.

34. The hoist frame according to any one of claims 21 to 33 wherein a deforming actuator is mounted parallel to the first outer inclined member, said member extendable by the force applied by the deforming actuator.

35. The hoist frame according to claim 34 wherein the deforming actuator is arranged such that on activation the shape of the first parallelogram is deformed to a quadrilateral shape having no parallel sides, causing rotation of the first head frame about the longitudinal axis.

36. The hoist frame according to any one of claims 21 to 35, wherein on release of the actuators, the assembly is self adjustable based on the application of an external force.
